(19) United States
(12) Patent Application Publication
(10) Pub. No.: US 2025/0104549 A1
(43) Pub. Date: Mar. 27, 2025

(54) RECEIVING NOTIFICATIONS WHILE OPERATING IN DIFFERENT MODES

(71) Applicant: Apple Inc., Cupertino, CA (US)

(72) Inventors: Thomas G. SALTER, San Francisco, CA (US); Jeffrey S. NORRIS, Saratoga, CA (US); Christopher I. WORD, San Francisco, CA (US); Alexandria G. HESTON, San Francisco, CA (US); Thomas J. MOORE, Northglenn, CO (US); Michael J. ROCKWELL, Palo Alto, CA (US); Anshu K. CHIMALAMARRI, Sunnyvale, CA (US); Benjamin S. PHIPPS, San Francisco, CA (US); Jessica TRINH, Oakland, CA (US); Sanjana WADHWA, San Francisco, CA (US)

(21) Appl. No.: 18/893,788

(22) Filed: Sep. 23, 2024

Related U.S. Application Data
(60) Provisional application No. 63/585,184, filed on Sep. 25, 2023.
(60) Provisional application No. 63/669,639, filed on Jul. 10, 2024.

(51) Int. Cl. G08B 21/18; G06F 3/01; G06V 20/20; G06V 20/50; G06V 40/10; G10L 25/51

(52) U.S. Cl. CPC G08B 21/182; G06F 3/011; G06V 20/20; G06V 20/50; G06V 40/10; G10L 25/51

(57) ABSTRACT

This relates generally to systems and methods of presenting extended reality environments and, more particularly, to displaying notifications while operating in different modes while presenting an extended reality environment. In some situations, the electronic device detects an event that satisfies one or more first criteria including a criterion that is satisfied when detecting an interaction with a person using at least an optical sensor. In some examples, in response to detecting the event, the electronic device transitions from a first mode to a second mode. In some examples, the electronic device receives a notification while operating in the second mode. In some examples, if one or more second criteria are satisfied, then the electronic device does not present the notification while in the second mode.

### CROSS-REFERENCE TO RELATED APPLICATIONS

This application claims the benefit of U.S. Provisional Application No. 63/585,184, filed Sep. 25, 2023, and U.S. Provisional Application No. 63/669,639, filed Jul. 10, 2024, the contents of which are herein incorporated by reference in their entireties for all purposes.

### FIELD OF THE DISCLOSURE

This relates generally to systems and methods for receiving notifications at an electronic device while the electronic device is operating in different modes, and more particularly to receiving notifications while operating in different modes on an extended reality device.

### BACKGROUND OF THE DISCLOSURE

Some computer graphical environments provide two-dimensional and/or three-dimensional environments where at least some objects presented for a user's viewing are virtual and generated by a computer. In some examples, computer graphical environments can be based on one or more images of the physical environment of the computer. A user may preprogram modes that inform an electronic device on how notifications should be presented while the electronic device is in a given mode. There is a need for an electronic device to automatically detect changes in the physical environment and transition from a first mode to a second mode of operation automatically.

### SUMMARY OF THE DISCLOSURE

This relates generally to systems and methods of presenting extended reality environments and, more particularly, to displaying notifications while operating in different modes while presenting an extended reality environment. In some examples, presenting the extended reality environment with an electronic device includes presenting pass-through video of the physical environment of the electronic device. As described herein, for example, presenting pass-through video can include displaying virtual or video passthrough in which the electronic device uses a display to display images of the physical environment. In other examples, presenting the extended reality environment with an electronic device includes presenting true or real optical see-through in which portions of the physical environment are visible to the user through a transparent portion of the display. In some situations, the electronic device detects an event that satisfies one or more first criteria including a criterion that is satisfied when detecting an interaction with a person using at least an optical sensor. In some examples, in response to detecting the event, the electronic device transitions from a first mode to a second mode. In some examples, the electronic device receives a notification while operating in the second mode. In some examples, if one or more second criteria are satisfied, then the electronic device does not present the notification while in the second mode.

The full descriptions of these examples are provided in the Drawings and the Detailed Description, and it is understood that this Summary does not limit the scope of the disclosure in any way.

### BRIEF DESCRIPTION OF THE DRAWINGS

FIG. 1 illustrates an electronic device presenting an extended reality environment according to some examples of the disclosure.

FIG. 2 illustrates a block diagram of an example architecture for a device according to some examples of the disclosure.

FIGS. 3A-3D illustrate an example of an event that satisfies one or more criteria and the resulting transition of the electronic device from a first mode to a second mode according to some examples of the disclosure.

FIGS. 4A-4C illustrate an example of a second event that satisfies one or more criteria and the resulting transition of the electronic device from a first mode to a third mode according to some examples of the disclosure.

FIG. 5 illustrates an example of notifications that are presented on a second electronic device and not the electronic device according to some examples of the disclosure.

FIG. 6A-6C illustrates an example of presenting summaries of notifications that are received while the electronic device is in second mode according to some examples of the disclosure.

FIG. 7 illustrates an example process of how an electronic device detects an event and transitions modes as a result of the event according to some examples of the disclosure.

### DETAILED DESCRIPTION

This relates generally to systems and methods of presenting extended reality environments and, more particularly, to displaying notifications while operating in different modes while presenting an extended reality environment. In some examples, presenting the extended reality environment with an electronic device includes presenting pass-through video of the physical environment of the electronic device. As described herein, for example, presenting pass-through video can include displaying virtual or video passthrough in which the electronic device uses display to display images of the physical environment. In other examples, presenting the extended reality environment with an electronic device includes presenting true or real optical see-through in which portions of the physical environment are visible to the user through a transparent portion of the display. In some situations, the electronic device detects an event that satisfies one or more first criteria including a criterion that is satisfied when detecting an interaction with a person using at least an optical sensor. In some examples, in response to detecting the event, the electronic device transitions from a first mode to a second mode. In some examples, the electronic device receives a notification while operating in the second mode. In some examples, if one or more second criteria are satisfied, then the electronic device does not present the notification while in the second mode. In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

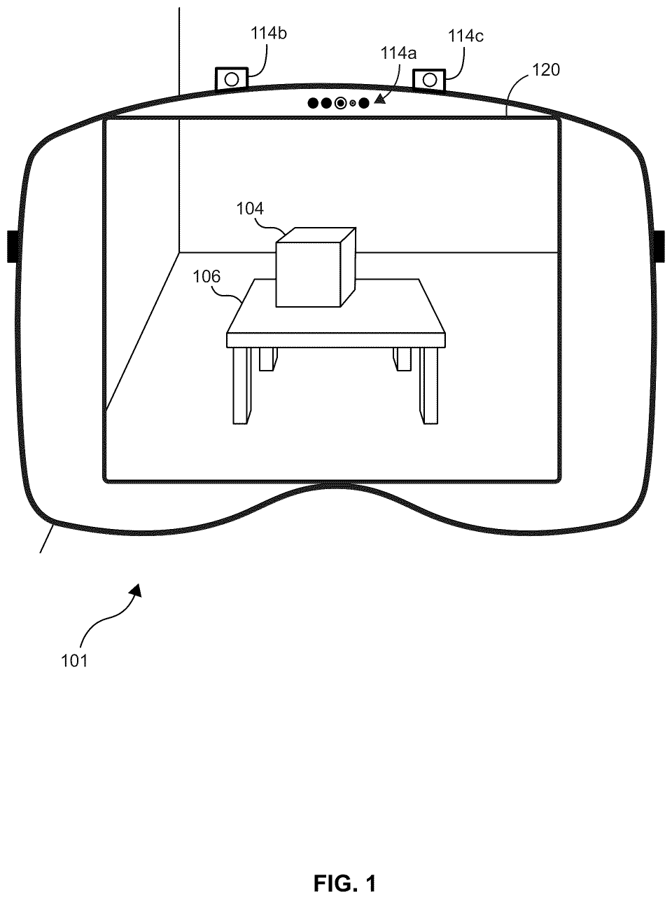

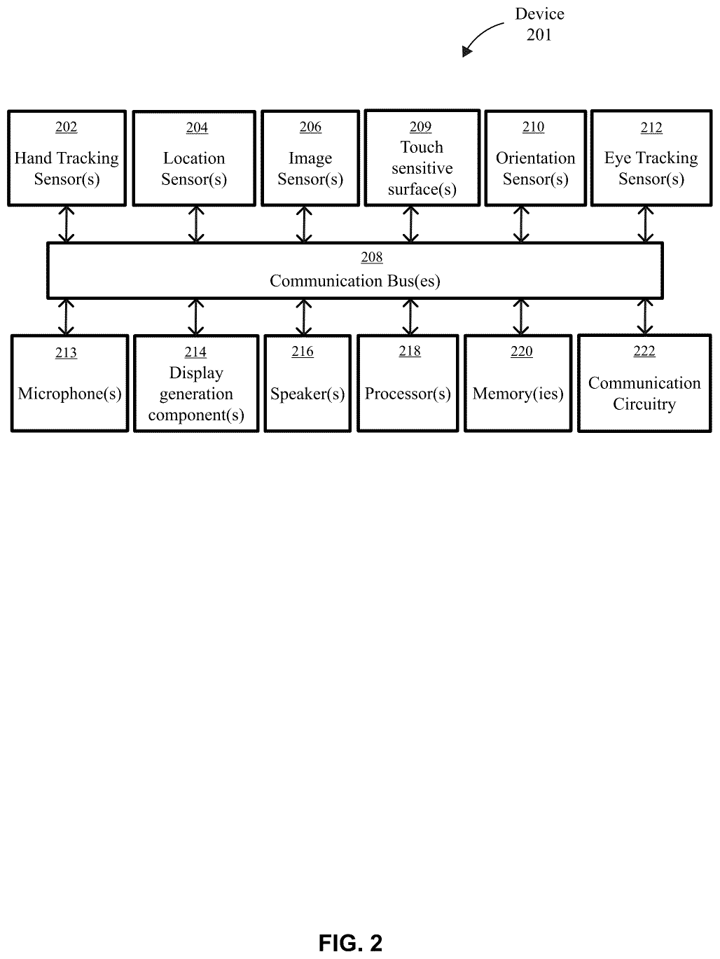

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101) using display 120.

In some examples, as shown in FIG. 1, display 120 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, display 120 also includes external image sensors 114b and 114c facing outwards from the user to detect and/or capture the physical environment of the electronic device 101 and/or movements of the user's hands or other body parts.

In some examples, display 120 has a field of view (e.g., a field of view captured by external image sensors 114b and 114c and/or visible to the user via display 120). Because display 120 is optionally part of a head-mounted device, the field of view of display 120 is optionally the same as or similar to the field of view of the user's eyes. In some examples, display 120 is a transparent or translucent display through which portions of the physical environment in the field of view of electronic device 101. For example, the computer-generated environment includes optical see-through or video-passthrough portions of the physical environment in which the electronic device 101 is located.

In some examples, in response to a trigger, the electronic device 101 may be configured to display a virtual object 104 in the XR environment represented by a cube illustrated in FIG. 1, which is not present in the physical environment, but is displayed in the XR positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for an electronic device 201 according to some examples of the disclosure. In some examples, electronic device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., leg, torso, head, or hands of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards interactions with one or more virtual objects that are displayed in a three-dimensional environment presented at an electronic device (e.g., corresponding to electronic device 201 and/or electronic device 101). In some examples, the electronic device adjusts the presentation of notifications in the three-dimensional environment in accordance with a detected event and a transition in mode. As discussed below, the electronic device may detect, using one or more input devices (e.g., image sensor(s) 206, orientation sensor(s) 210, audio sensors, and other sensors), an event, such as an interaction with a person at a specific location. In some examples, and as described below, the electronic device automatically changes modes of operation based on the detected event. In some examples, the different modes control the manner in which notifications are presented in the three-dimensional environment. Manually switching modes of operation of an electronic device depending on events is time-consuming. Some existing electronic devices allow a user to create and/or modify different modes of operation that control the presentation of notifications differently. However, these existing devices do not automatically detect present events and do not automatically switch modes of operation based on the detected events.

To solve the technical problem outlined above, exemplary methods and/or systems are provided in which an electronic device is configured to detect (e.g., and identify/classify) events and transition operating modes of the electronic device accordingly. When events for which the user does not want notifications to be presented are detected, the electronic device automatically switches from a first mode (e.g., a current operating mode) to a second mode so that the user does not need to manually silence notifications.

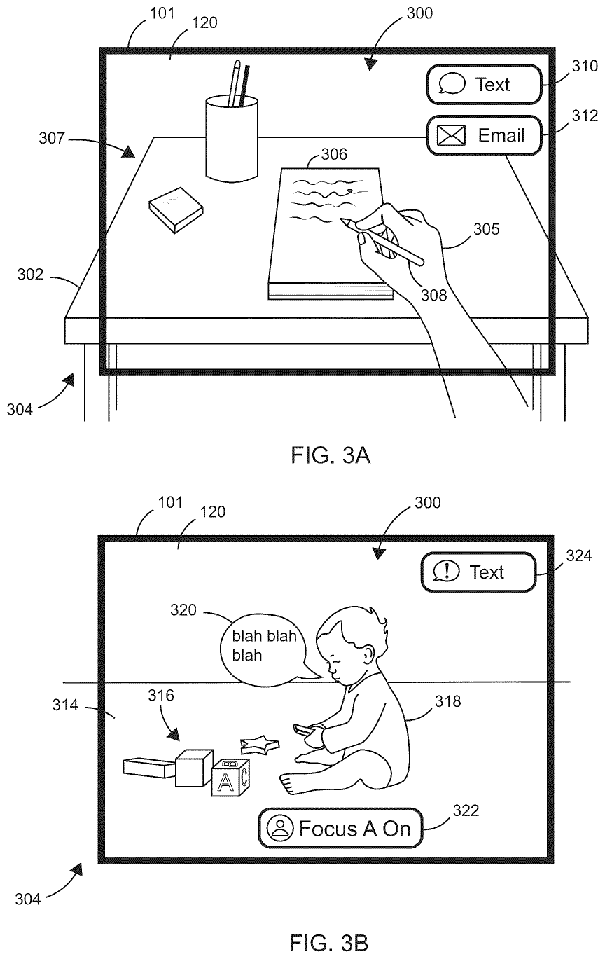

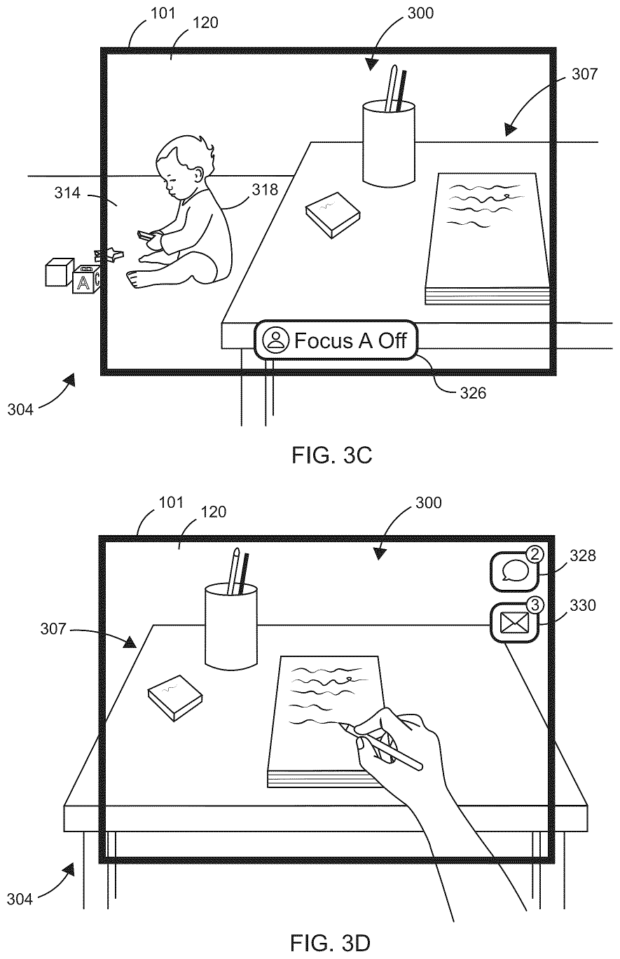

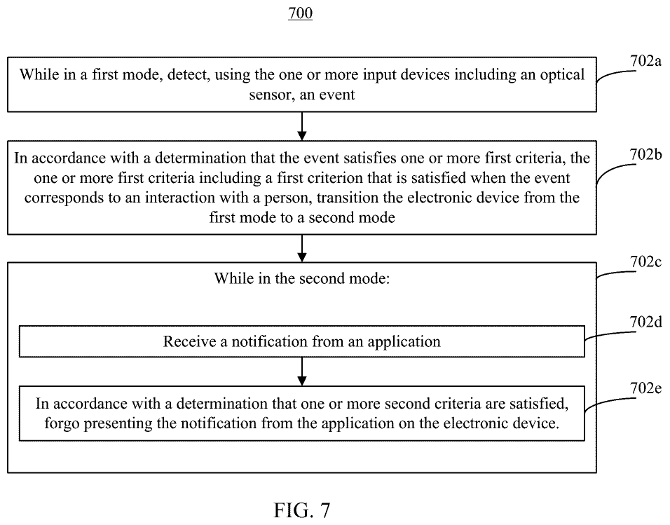

FIGS. 3A-3D illustrate an example of an event that satisfies the one or more first criteria and the resulting transition of the electronic device from the first mode to the second mode according to some examples of the disclosure. FIGS. 3A-3D are used to illustrate the processes described below, including process 700 in FIG. 7.

FIG. 3A illustrates an electronic device 101 presenting, via the display 120, a three-dimensional environment 300 from a point of view of the user of the electronic device 101 (e.g., facing a desk 302 in a room in which electronic device 101 is located). In some examples, a viewpoint of a user determines what content (e.g., physical and/or virtual objects) is visible in a viewport (e.g., a view of the three-dimensional environment 300 visible to the user via one or more display(s) 120, a display or a pair of display modules that provide stereoscopic content to different eyes of the same user). In some examples, the (virtual) viewport has a viewport boundary that defines an extent of the three-dimensional environment 300 that is visible to the user via the display 120 in FIGS. 3A-3D. In some examples, the region defined by the viewport boundary is smaller than a range of vision of the user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the user in one or more dimensions (e.g., based on the range of vision of the user, size, optical properties or other physical characteristics of the one or more displays, and/or the location and/or orientation of the one or more displays relative to the eyes of the user). The viewport and viewport boundary typically move as the one or more displays move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location, a direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include displays with video passthrough, portions of the physical environment that are visible (e.g., displayed, and/or projected) via the one or more displays are based on a field of view of one or more cameras in communication with the displays which typically move with the displays (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more displays is updated based on the viewpoint of the user (e.g., displayed positions and poses of the virtual objects are updated based on the movement of the viewpoint of the user)). For displays with optical see-through, portions of the physical environment that are visible (e.g., optically visible through one or more partially or fully transparent portions of the display generation component) via the one or more displays are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the displays moves (and the appearance of one or more virtual objects is updated based on the viewpoint of the user).

In FIG. 3A, the electronic device 101 includes a display 120 and a plurality of sensors as described above and controlled by the electronic device 101 to capture one or more images of a user or part of a user (e.g., one or more hands of the user, such as hand 305) while the user interacts with the electronic device 101. In some examples, virtual objects, virtual content, and/or user interfaces illustrated and described below could also be implemented on a head-mounted display that includes a display or display generation component that displays the virtual objects, virtual content, user interfaces or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user). The figures herein illustrate a three-dimensional environment that is presented to the user by electronic device 101 (e.g., and displayed by the display 120 of electronic device 101). In some examples, electronic device 101 may be similar to device 101 in FIG. 1, or device 201 in FIG. 2, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively.

As shown in FIG. 3A, the electronic device 101 captures (e.g., using external image sensors 114b and 114c) one or more images of a physical environment 304 around electronic device 101, including one or more objects (e.g., desk 302, paper 306, and pen 308) in the physical environment 304 surrounding the electronic device 101. In some examples, the electronic device 101 displays representations of the physical environment 304 in the three-dimensional environment or portions of the physical environment 304 are visible via the display 120 of electronic device 101. For example, the three-dimensional environment 300 includes desk 302, paper 306, and pen 308 in the physical environment 304.

In some examples, the electronic device 101 receives indications from various applications running on the electronic device. While in physical environment 304, the electronic device 101 is operating in a first mode. In some examples, the first mode is a mode in which the electronic device 101 receives indications from various applications and displays visual indications representing the indications without delay (e.g., in real time). While in physical environment 304, the electronic device 101 presents the indications as visual indications 310 and 312 in the three-dimensional environment 300, as shown in FIG. 3A. Visual indication 310 is a notification received from a text messaging application on electronic device 101 or an electronic device communicatively connected to the electronic device 101. Visual indication 312 is a notification received from an email application on the electronic device 101 or an electronic device communicatively connected to the electronic device 101. In some examples, a second electronic device is communicatively connected to the electronic device 101 using wireless communication (e.g., WiFi, Bluetooth, and/or near field communications), physical communication (e.g., ethernet or other wired communications), and/or a shared user account (e.g., a user is logged into both devices). In some examples, the second electronic device may be a computer, phone, smart watch, tablet, or other electronic device capable of sending and receiving communications. In some examples, a user may receive a notification from an application on the second electronic device and a visual indication may be presented on both electronic device 101 and the second electronic device, or only on one of the two devices. The second electronic device is described in greater detail with reference to FIG. 5 below.

In some examples, the electronic device 101 detects a change in contextual information of the physical environment 304 indicating that the current location of the electronic device 101 corresponds to a play area 314, as shown in FIG. 3B. In some examples, the user moves from an office area 307 (e.g., including the desk 302), shown in FIG. 3A, to a play area 314 shown in FIG. 3B. In some examples, office area 307 and play area 314 may be in different locations, such as in different buildings, or different addresses. In some examples, office area 307 and play area 314 may be in the same location, such as in different rooms in one building. As shown in FIG. 3B, play area 314 includes different objects, such as building blocks 316. Play area 314 also includes a person 318. Person 318 may be associated with the user (e.g., is known by the user). For example, person 318 is a child of the user. In some examples, and as shown in FIG. 3B, the person 318 is interacting with the user of the electronic device 101.

In some examples, the electronic device 101 detects an event that satisfies one or more first criteria. In some examples, the one or more first criteria are satisfied when the electronic device 101 detects an interaction between the user and another person. In some examples, the interaction is a physical interaction (e.g., hugging a person, playing with a person, shaking hands with a person, or other physical interactions) and/or a verbal interaction (e.g., conversation). In some examples, playing with a person may include direct and indirect playing, such as assembling a model together, building sandcastles together, or playing cards together. For example, in FIG. 3B, the user of electronic device 101 interacts with person 318 through conversation 320 and through building blocks 316. In some examples, the electronic device 101 detects an utterance to and from the person 318. For example, the electronic device 101 detects that the person 318 is speaking to the user using microphones (e.g., microphone 213, as described above). In some examples, the electronic device 101 may use image sensors (e.g., image sensors 206) and/or motions sensors (e.g., orientation sensors 210) to determine physical interactions, such as playing with the building blocks 316 with the person 318. In some examples, the user of the electronic device 101 determines the one or more first criteria for the electronic device 101 to transition from operating in the first mode to the second mode. For example, the one or more first criteria may include a criterion that is satisfied when the user interacts with a known person, while the user is in a specified location (e.g., at home, at work, and/or other known locations), and/or during specific times in the day (e.g., scheduled working hours or other calendar-related events). In some examples, the electronic device 101 uses the one or more sensors including image sensors 206 to determine an identity of the person (e.g., whether the person is a known person). In some examples, the electronic device 101 uses other sensors (e.g., location sensors 204, image sensors 206, and/or other sensors) to determine if the event satisfies the one or more first criteria as defined by the user of the electronic device 101.

In some examples, in response to determining that the event satisfies the one or more first criteria, the electronic device 101 transitions from operating in a first mode to a second mode. Alternatively, if the event does not satisfy the one or more first criteria, the electronic device 101 does not transition to the second mode. For example, the electronic device 101 may remain in the first mode if the change in contextual information (e.g., from office area 307 to play area 314) and the resulting interactions do not satisfy the one or more first criteria as specified by the user of the electronic device 101 above. In some examples, the second mode is a mode in which, if the electronic device 101 receives indications from various applications running on the electronic device 101, the electronic device 101 delays (e.g., forgoes) displaying visual indications of the indication until the second mode is turned off. For example, the visual indications may be delayed a variable amount of time that is dependent on when the qualifying event is no longer detected (e.g., the user is no longer interacting with person 318, as described in FIG. 3C). Alternatively or additionally, in some examples, the electronic device 101 suppresses (e.g., delays or forgoes) providing other types of notification feedback (e.g., haptic and/or audio feedback) while operating in the second mode. In response to transitioning to the second mode, the electronic device 101 displays visual indication 322. Visual indication 322 optionally includes text (“Focus A on”) that indicates that the electronic device 101 has transitioned to the second mode. Alternatively, in some examples, the electronic device 101 may transition between modes without displaying a visual indication indicating the change in modes.

In some examples, while operating in a mode (e.g., the second mode) that includes a delay in presentation of visual indications of indications from various applications, the electronic device 101 still displays critical notifications that are specified by the user of the electronic device 101. In some examples, the user of the electronic device 101 determines criteria that need to be satisfied for the electronic device 101 to display the visual indication of the notifications from the various applications while operating in the second mode. For example, notifications corresponding to a communication from a designated contact (e.g., a text from a designated contact such as a partner, parent, or other known contact) are still shown while in the second mode. As shown in FIG. 3B, the electronic device 101 displays visual indication 324 corresponding to a text message received from a designated contact. In some examples, communication from non-designated contacts (e.g., contacts not specified by the user, or unknown contacts) are not considered critical, and therefore are not displayed while the presentation of notifications are suppressed, such as in the second mode. In some examples, the user of the electronic device 101 may specify that notifications from specific applications are displayed while in the second mode (e.g., visual indications from a phone application).

In some examples, the electronic device 101 uses one or more machine learning techniques and/or artificial intelligence, implemented using hardware, firmware, software, or a combination thereof, to determine critical notifications. For example, the electronic device 101 optionally uses a large language model (LLM) to “read” the content of the incoming communication item and determine an importance of the communication item (e.g., the text message, email, voicemail, or other communication items). For example, the importance can be represented numerically (e.g., with opposite ends of a numerical range representing a lowest or highest rating of importance, or can be represented as a state (e.g., low, moderate, high, etc.). Communication items are described in greater detail below. In some examples, after determining the importance of the communication item, the electronic device 101 compares the importance to an importance threshold (e.g., importance may be ranked on a 1-10 scale and the importance threshold may be a 7, or on a 0 to 1 scale and the importance threshold may be 0.8, or the importance threshold may indicate a division between the importance states, etc.) to determine whether the communication item is important enough to be displayed while in the second mode. For example, a communication item that has an importance determined to be at or greater than the importance threshold can be displayed in the second mode, whereas a communication item that has an importance determined to be less than the importance threshold is not displayed in the second mode. In some examples, the importance threshold may be based on a busy-ness level of the user of the electronic device 101. For example, the importance threshold changes based on the busy-ness level of the user (e.g., the importance threshold increases for a higher level of busy-ness, decreases for a lower level of busy-ness). In some examples, the electronic device 101 determines the busy-ness level of the user based on contextual information gathered using the one or more sensors, as described above. For example, if the user is actively interacting with the physical environment (e.g., writing, reading, talking to other people), then the busy-ness level (and importance threshold) is higher than if the user is not actively interacting (e.g., passively interacting) with the physical environment (e.g., watching TV, scrolling on social media, or the like). For example, the importance threshold while the electronic device 101 detects that the user interacts with person 318 through conversation 320 and through building blocks 316 shown in FIG. 3B is higher than if the electronic device 101 detects that the user is consuming content watching TV, listening to music, browsing the web, etc. Alternatively, or additionally, in some examples, the importance threshold is based on the mode that the electronic device 101 is currently in. For example, while in the second mode (e.g., a mode indicating a heightened level of focus), as shown in FIG. 3B, the electronic device 101 has a higher importance threshold than while in the first mode, as shown in FIG. 3A.

For example, in FIG. 3B, the electronic device 101 displays visual indication 324 because the electronic device 101 determined (e.g., using the LLM as described above) that the importance level of the content of the communication item represented by indication 324 is greater than the importance threshold.

In some examples, the electronic device 101 uses machine learning and/or artificial intelligence, such as an LLM, to determine an opportunistic moment to display indications corresponds to communication items. For example, the electronic device 101 displays visual indications corresponding to communication items (e.g., both critical and/or non-critical communication items) at a time that the electronic device 101 determines is an opportune time to receive notifications. For example, the electronic device 101 uses the busy-ness level of the user to determine a less busy time to display visual indications. In some examples, displaying notifications at an opportune time allows the user to efficiently view notifications without distractions.

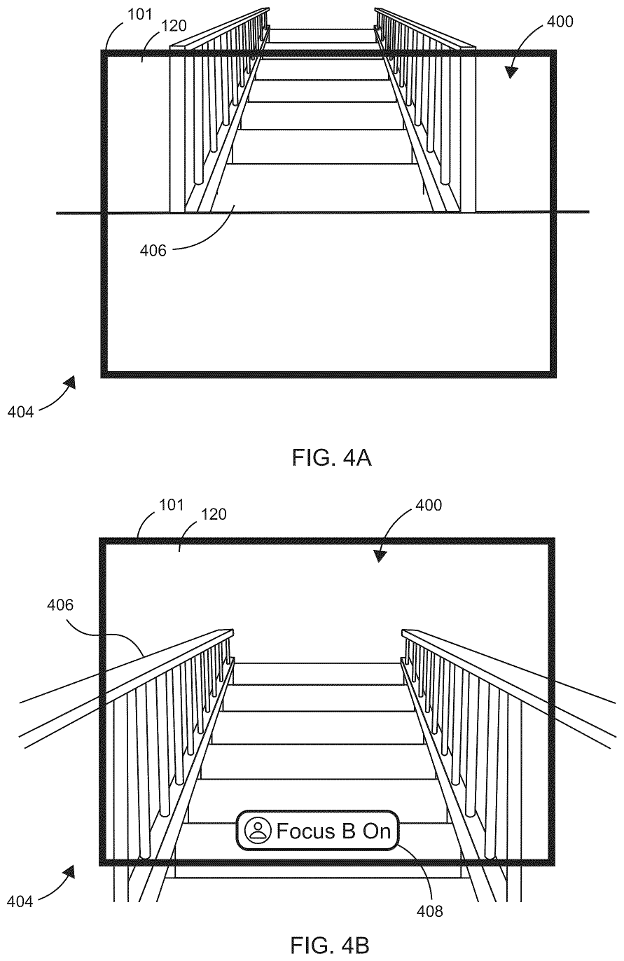

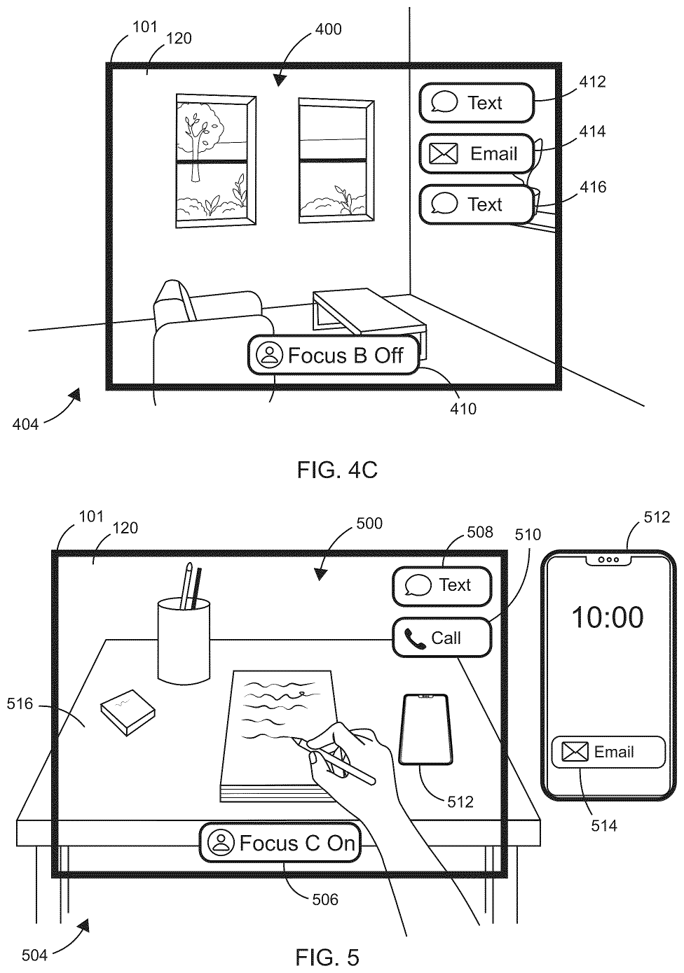

In some examples, the electronic device 101 detects a change in contextual information of the physical environment. For example, the event that triggers the change in mode from the first mode to the second mode is removed (e.g., the electronic device 101 detects movement to a location at which the one or more first criteria are no longer satisfied or determines that the event no longer satisfies the one or more first criteria). For example, the user of the electronic device 101 is no longer interacting with person 318 in FIG. 3C because the current location of the electronic device 101 changes from the play area 314 back to the office area 307. In some examples, the triggering event could end when the person 318 stops interacting with the user of the electronic device 101 (e.g., the electronic device 101 detects the person 318 is no longer talking to or physically contacting the user of the electronic device 101). In some examples, the electronic device 101 transitions back to operating in the first mode from the second mode in response to no longer detecting the triggering event. Alternatively, in some examples, the electronic device 101 transitions from operating in the second mode to a different, third mode in response to no longer detecting the triggering event for the second mode. For example, the electronic device 101 optionally detects a different event that satisfies the criteria necessary for a third mode of operation and then transitions to the third mode (from the second mode or the first mode), which is described in greater detail below with reference to FIGS. 4A-4C. In some examples, the electronic device 101 displays visual indication 326 in response to detecting the change in contextual information indicating that the triggering event is no longer present, as shown in FIG. 3C. In some examples, the electronic device 101 changes from operating in the second mode to the first mode without displaying a visual indication.

In some examples, transitioning back to operating in the first mode (e.g., from the second mode) includes presenting the visual indications that were suppressed while in the second mode as shown in FIG. 3D. For example, electronic device 101 displays visual indication 328 in FIG. 3D in response to receiving one or more indications from a messaging application (e.g., 2 text messages) running on electronic device 101 (or a second electronic device communicatively connected to the electronic device 101) while operating in the second mode. Electronic device 101 also displays visual indication 330 in the three-dimensional environment 300, as shown in FIG. 3D, in response to receiving one or more indications from an email application (e.g., 3 emails) running on electronic device 101 (or a second electronic device communicatively connected to the electronic device 101) while operating in the second mode.

FIGS. 4A-4C illustrate an example of a second event that satisfies one or more criteria and the resulting transition on the electronic device from operating in a first mode to a third mode according to some examples of the disclosure. FIGS. 4A-4C are used to illustrate the processes described below, including process 700 in FIG. 7.

FIG. 4A illustrates the electronic device 101 displaying, via the display 120, a three-dimensional environment 400 from a point of view of the user of the electronic device 101 (e.g., facing the stairs 406 in a room in which electronic device 101 is located). In some examples, three-dimensional environment 400 has one or more characteristics of three-dimensional environment 300 described with reference to FIG. 3A. In some examples, and as shown in FIG. 4A, the electronic device 101 captures one or more images of a physical environment 404 surrounding electronic device 101, including one or more objects (e.g., stairs 406) in the physical environment 404 around the electronic device 101. In some examples, the physical environment 404 includes one or more characteristics of the physical environment 304 described in FIG. 3A.

In some examples, the electronic device 101 is operating in the first mode, which was described previously above with reference to FIGS. 3A-3C, while the user is not actively on the stairs 406, as shown in FIG. 4A. In some examples, the electronic device 101 detects a change in contextual information of the physical environment 404 indicating that the current location of the electronic device 101 is over the stairs 406 (e.g., the user of the electronic device 101 is positioned on the stairs 406 in the physical environment 404), as shown in FIG. 4B. As a result, the electronic device 101 optionally transitions from operating in the first mode to a third mode (e.g., different from the second mode discussed previously above). In some examples, and as shown in FIG. 4B, the electronic device 101 displays visual indication 408 indicating that the electronic device 101 is operating in the third mode. In some examples, the third mode is a mode in which, if the electronic device 101 receives indications from various applications running on the electronic device 101, the electronic device 101 delays (e.g., forgoes) displaying visual indications of the indication for a threshold amount of time. For example, the threshold amount of time may be 1 second, 1 minute, 5 minutes, 30 minutes, or an hour. In some examples, the user of the electronic device 101 may specify the threshold amount of time (e.g., by inputting it into a modes settings user interface). In some examples, the user may specify the criteria that need to be satisfied (e.g., a triggering event) for the electronic device 101 to transition to a third mode. For example, the third mode is reserved for activities that need short term attention, and the user of the electronic device 101 may specify those activities and/or criteria that need to be satisfied. For example, the activities may include walking down (or up) the stairs (as shown in FIG. 4B). In some examples, the third mode is activated (e.g., automatically) when the electronic device 101 detects an obstacle (e.g., by using image sensors 206) while operating in a navigational context (e.g., determined by location sensors 204 and/or orientation sensors 210). For example, obstacles may include stairs, escalators, crosswalks, train platforms, moving platforms, or other obstacles. For example, a navigational context may include walking on foot, driving or riding in a vehicle, or other forms of transportation and navigation. In some examples, the determination that the electronic device 101 is operating in a navigational context is based on data provided by a navigation application operating on the electronic device 101. For example, the electronic device 101 is operating in the navigational context if the user is actively navigating to a particular destination via the navigation application.

FIG. 4C illustrates the electronic device 101 transitioning back to the first mode from the third mode. In some examples, after a threshold amount of time has elapsed, the electronic device 101 transitions back to the first mode. In some examples, and as shown in FIG. 4C, the electronic device 101 switches back to the first mode after detecting a change in contextual information of the physical environment (e.g., the user of the electronic device 101 has moved, which causes the electronic device 101 to no longer be located on the stairs 406). In response to switching back to the first mode, the electronic device 101 displays visual indication 410 which indicates that the third mode is no longer active. In some examples, the electronic device 101 displays visual indications related to notifications (indications) received from various applications that have been delayed as a result of the third mode being active. For example, in FIG. 4C, the electronic device 101 displays visual indications 412, 414, and 416 when the electronic device 101 transitions back to the first mode. In some examples, visual indications 412, 414, and 416 may have a visual appearance similar to visual indications 328 and 330, described in FIG. 3D.

FIG. 5 illustrates an example of notifications that are presented on a second electronic device and not the electronic device according to some examples of the disclosure. FIGS. 4A-4C are used to illustrate the processes described below, including process 700 in FIG. 7.

FIG. 5 illustrates the electronic device 101 displaying, via the display 120, a three-dimensional environment 500 from a point of view of the user of the electronic device 101. In some examples, three-dimensional environment 500 has one or more characteristics of three-dimensional environment 300 described with reference to FIG. 3A. In some examples, and as shown in FIG. 5, the electronic device 101 captures one or more images of a physical environment 504 surrounding electronic device 101, including one or more objects (e.g., desk 516) in the physical environment 504 around the electronic device 101. In some examples, the physical environment 504 includes one or more characteristics of the physical environment 304 described with reference to FIG. 3A. In FIG. 5, the physical environment 504 includes a second electronic device 512 in view of the electronic device 101 and the electronic device 101 uses the one or more sensors to identify electronic device 512. In some embodiments, identifying second electronic device 512 includes identifying that electronic device 512 is an electronic device and identifying that second electronic device 512 is in communication with electronic device 101. The second electronic device 512 is optionally a portable communications device such as a mobile telephone, laptop, tablet, smart watch, or other devices described herein. In some examples, the second electronic device 512 is communicatively connected to the electronic device 101 by way of wireless connection, wired connection, or a shared user account. For example, the user of electronic device 101 may have a user account that is associated with the electronic device 101 and the second electronic device 512 and to which the user is logged into on the electronic device 101 and the second electronic device 512.

In some examples, the electronic device 101 does not present visual representations for specific applications in response to receiving an indication from the applications. For example, the user may specify the applications and/or type(s) of notifications that the electronic device 101 does not display (e.g., as a visual representation) in three-dimensional environment 500. In some examples, the electronic device 101 does not present visual representations for the specified applications while in any mode or while in a specific mode (e.g., a fourth mode). For example, in FIG. 5, the electronic device 101 is in a fourth mode (e.g., the electronic device 101 includes and identifies the second electronic device 512 in the field of view and the electronic device 101 defers specific notifications to the second electronic device 512 to prevent duplicate notifications from being set to both electronic devices). In some examples, the electronic device 101 defers display of the visual representations that are not displayed in the three-dimensional environment 500 to a different electronic device, such as second electronic device 512, as shown in FIG. 5.

FIG. 5 illustrates that the electronic device 101 transitions to a fourth mode from the first mode. The electronic device 101 displays a visual indication 506 indicating that the fourth mode is active. In some examples, the user may manually change modes. For example, the user may manually transition the electronic device 101 from the first mode to any mode (e.g., the second mode, the third mode, or the fourth mode described herein) or vice versa (e.g., from the fourth mode to the first mode). In some examples, the fourth mode is a mode in which, if the electronic device 101 receives indications from various applications running on the electronic device 101, based on the particular application, the electronic device 101 defers display of the indication(s) to a different device. For example, the user of the electronic device 101 optionally indicates (e.g., through a settings user interface) that visual indications received from an email application are not displayed on the electronic device 101 but are allowed to be displayed on other devices. As shown in FIG. 5, visual indication 514, which is associated with the email application, is not displayed on the electronic device 101 but is displayed on the second electronic device 512 (e.g., on a touchscreen of the second electronic device 512). The electronic device 101 optionally continues to display visual indications 508 and 510, which are associated with a phone application and a messaging application, respectively, while forgoing displaying visual indications associated with the email application, as shown in FIG. 5.

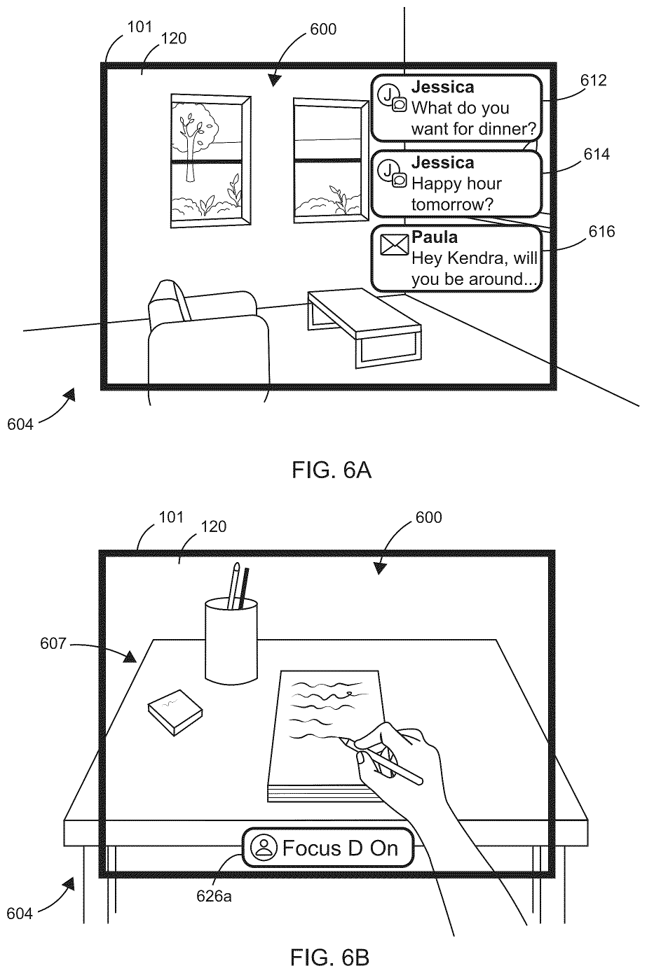

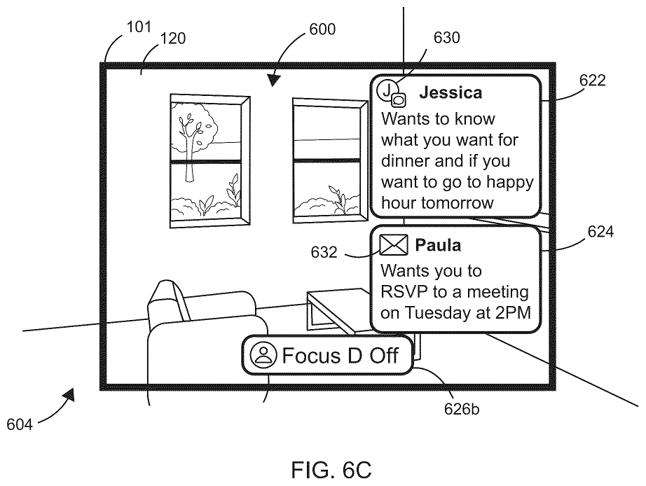

FIG. 6A-6C illustrates electronic device 101 presenting summaries of notifications in a first mode that are received while the electronic device 101 is in a second mode. In FIGS. 6A-6C, the electronic device 101 displays, via the display 120, a three-dimensional environment 600 from the point of view of the user of electronic device 101. In some examples, the three-dimensional environment 600 has one or more characteristics of three-dimensional environment 300 described with reference to FIG. 3A.

FIG. 6A illustrates an example wherein the electronic device 101 presents notifications while in a first mode. In some examples, the first mode is described in greater detail above, and shown in FIG. 3A. In FIG. 6A, the electronic device 101 captures (e.g., using external image sensors 114b and 114c) one or more images of a physical environment 604 around electronic device 101. In FIG. 6A, the physical environment 604 corresponds to the physical environment 404, described with reference to FIG. 4C. In some examples, the electronic device 101 receives indications from various applications without delay in the first mode. Additionally, in some examples, the electronic device 101 displays a preview of the content of a communication item corresponding to the indication. For example, in FIG. 6A, the electronic device 101 displays indications 612, 614, and 616. Indications 612 and 614 are indications of communication items from a text messaging application. Indication 616 is an indication of a communication item from an email application. Indications 612, 614, and 616 include previews of the content of the respective communication items. In some examples, the preview of the content of the respective communication item is a direct copy of a portion of the content of the respective communication item. For example, indications 612 and 614 include a preview of the respective text message and indication 616 includes a preview of the respective email, as shown in FIG. 6A.

FIG. 6B illustrates an example of electronic device 101 receiving notifications while in the second mode, and FIG. 6C illustrates an example of electronic device 101 then displaying the indications corresponding to the notifications after reentering the first mode. In FIG. 6B, the electronic device 101 is in the second mode, as illustrated by visual indication 626a. In some examples, indication 626a has one or more characteristics of indication 322, described with reference to FIG. 3B. In some examples, the second mode is described in greater with reference to FIG. 3B. In FIG. 6B, the electronic device 101 does not display indications of notifications while in the second mode. In some examples, and as described above, the electronic device 101 delays the presentation of indications while in the second mode. For example, in FIG. 6B, the electronic device receives the text messages from Jessica and the email from Paula (e.g., illustrated by indications 612, 614, and 616, shown in FIG. 6A).

In some examples, the electronic device 101 transitions to the second mode from the first mode because the electronic device 101 detects an event that satisfies one or more first criteria. For example, electronic device 101 detects a change in contextual information of the physical environment (e.g., the electronic device 101 detects a movement of the electronic device 101 from the living room, shown in FIG. 6A, to an office area 607, shown in FIG. 6B). In some examples, office area 607 has one or more characteristics of office area 307 described with reference to FIG. 3A. In some examples, the one or more first criteria are satisfied when the electronic device 101 detects that a user of the electronic device 101 is involved in an activity. For example, in FIG. 6B, the electronic device 101 detects that the user is working (e.g., writing).

In FIG. 6C, the electronic device 101 transitions back to the first mode, as indicated by visual indication 626b, which has one or more characteristics of visual indication 326, shown in FIG. 3C. In some examples, the electronic device 101 detects that the one or more first criteria are no longer satisfied (or that one or more second criteria are satisfied). For example, the electronic device 101 detects a change in contextual information of the physical environment (e.g., the electronic device 101 detects a movement of the electronic device 101 to the living room, shown in FIG. 6C, from the office area 607, shown in FIG. 6B), and as such, the electronic device 101 detects that the user is no longer working. In response to changing the mode from the second mode to the first mode, the electronic device 101 displays indications 622 and 624, shown in FIG. 6C. In some examples, indications 622 and 624 correspond to indications 612, 614, and 616, shown in FIG. 6A.

In some examples, in response to detecting the change in mode from the second mode back to the first mode, the electronic device 101 summarizes the one or more communication items received while in the second mode (e.g., communication items corresponding to indications 612, 614, and 616). Alternatively, in some examples, the electronic device 101 summarizes the one or more communication items received while in the second mode prior to detecting the change in mode from the second mode back to the first mode. In some examples, the electronic device 101 displays the summarization after detecting the change in mode. In some examples, the electronic device 101 categorizes the indications by application of origin (e.g., categorize all communications from a specific application into one element of the summary) and/or by a sender (e.g., categorize all communications from a specific sender into one element of the summary). In some examples, the electronic device 101 includes all communication items (e.g., communication items from different applications (e.g., email, phone, texts, voicemails, or other communication items)) from a respective sender into one summary indication. For example, indication 622 summarizes the communication items corresponding to indications 612 and 614 from a text messaging application and/or from the sender “Jessica”, and indication 624 summarizes the communication items corresponding to indication 616 of an email application and/or from the sender, “Paula”, as shown in FIG. 6C. In FIG. 6C, the electronic device 101 displays indication 630 in indication 622 and indication 632 in indication 624. Indication 630 includes a representation of the sender of the messages (e.g., the “J” icon for Jessica) and a representation of what application (e.g., text messaging application) the messages originated from (e.g., the messages icon) in the summary represented by indication 622. In FIG. 6C, the electronic device 101 displays indication 632, which is a different example of an indication representing the communication items of the summary (e.g., represented by indication 624). Indication 632 includes an icon (e.g., the mail icon) representing the application associated with the contents summarized by indication 624.

In some examples, the electronic device creates the summary of the communication item using one or more artificial intelligence methods and/or machine learning models. For example, the electronic device 101 uses large language models (LLMs) to summarize the content of communication items. In some examples, the LLMs are stored on the electronic device 101, on a server (e.g., cloud server), or on the internet in communication with the electronic device 101. In some examples, the summary of the communication item summarizes the contents of the communication item. In some examples, the summary does not include a direct copy of (a portion or all of) the text and/or images in the contents of the communication item. For example, the summary is not word for word in the contents of the communication item. In FIG. 6C, indications 622 and 624 include summaries of indications 612 through 616, which are not word for word copies of the content in indications 612 through 616 (e.g., paraphrasing, etc.).

In some examples, while FIG. 6C illustrates the indications of communication items that include a summarization of the contents of the communication items in response to the electronic device 101 transitioning from the second mode to the first mode, the indications of communication items that include a summarization of the contents of the communication items is not limited to the first or second modes. For example, the electronic device 101 displays the indications of communication items that include a summarization of the contents of the communication items in the first mode after transitioning from the third mode. In some examples, providing summaries of notifications that were previously suppressed allows a user to quickly and efficiently view notifications, thereby reducing the number of inputs to the electronic device and/or improves the user experience by enabling the user to consume the notifications in an efficient manner without reading each of the notifications/communication items in full.

FIG. 7 illustrates an example process of how an electronic device detects an event and transitions modes as a result of the event. In some examples, process 700 begins at an electronic device in communication with one or more displays and one or more input devices. In some examples, the electronic device is optionally a head-mounted display similar or corresponding to device 201 of FIG. 2. As shown in FIG. 7, in some examples, while in a first mode, the electronic device, such as electronic device 101, detects (702a), using the one or more input devices including an optical sensor, an event, such as using sensors such microphone 213, image sensors 206, and/or orientation sensors 210 to detect contextual information. For example, the event is an interaction with a person, such as person 318 in FIG. 3C.

In some examples, in accordance with a determination that the event satisfies one or more first criteria, the one or more first criteria including a first criterion that is satisfied when detecting an interaction with a person, the electronic device transitions (702b) from the first mode to a second mode, such as shown with the display of visual indication 322 in FIG. 3B.

In some examples, while in the second mode (702c), the electronic device receives (602d) a notification from an application. For example, the electronic device 101 receives a notification from a messaging application indicating that the user has received a text message from a different user. In some examples, if the user were not in the second mode, the notifications would be displayed as visual indications, such as visual indications 310 and 312, in FIG. 3A.

In some examples, while in the second mode (702c), in accordance with a determination that one or more second criteria are satisfied, the electronic device (702e) forgoes presenting the notification (e.g., haptic, audio message, visual notification) from the application on the electronic device. For example, as shown in FIG. 3B, only notifications (e.g., visual indication 324) that do not satisfy the one or more second criteria are displayed on the electronic device 101. In some examples, the electronic device 101 determines notification that do not satisfy the one or more second criteria using machine-learning and/or artificial intelligence (e.g., an LLM). For example, as described above, notifications that have an importance greater than the importance threshold are displayed in the second mode.

In some examples, after the electronic device 101 transitions back to the first mode (e.g., after the one or more first criteria are no longer satisfied), the electronic device 101 optionally displays one or more indications summarizing the content of the notifications received while the electronic device 101 was in the second mode, as described in FIGS. 6A-6C.

It is understood that process 700 is an example and that more, fewer, or different operations can be performed in the same or in a different order. Additionally, the operations in process 700 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising at an electronic device in communication with one or more displays and one or more input devices: while in a first mode, detecting, using the one or more input devices including an optical sensor, an event; in accordance with a determination that the event satisfies one or more first criteria, the one or more first criteria including a first criterion that is satisfied when the event corresponds to an interaction with a person, transitioning the electronic device from the first mode to a second mode; while in the second mode: receiving a notification from an application; and in accordance with a determination that one or more second criteria are satisfied, forgoing presenting the notification from the application on the electronic device. Additionally or alternatively to one of more of the examples disclosed above, in some examples, the method further comprises in accordance with a determination that the event does not satisfy the one or more first criteria, foregoing transitioning the electronic device from the first mode to the second mode. Additionally or alternatively to one of more of the examples disclosed above, in some examples, the method further comprises while in the second mode, in accordance with a determination that the event has ended, transitioning the electronic device from the second mode to the first mode. Additionally or alternatively to one of more of the examples disclosed above, in some examples, the method further comprises in response to transitioning the electronic device from the second mode to the first mode, presenting one or more notifications that were received and not presented while in the second mode. Additionally or alternatively to one of more of the examples disclosed above, in some examples, the method further comprises detecting the event using the one or more input devices including the optical sensor comprises determining an identity of the person. Additionally or alternatively to one of more of the examples disclosed above, in some examples, the method further comprises detecting the event using the one or more input devices including the optical sensor comprises detecting a physical interaction with the person. Additionally or alternatively to one of more of the examples disclosed above, in some examples, the method further comprises detecting the event further includes detecting audio information using the one or more input devices. Additionally or alternatively to one of more of the examples disclosed above, in some examples, the method further comprises detecting audio information further comprises detecting an utterance to or from the person. Additionally or alternatively to one of more of the examples disclosed above, in some examples, the method further comprises detecting the event further includes detecting location information using the one or more input devices. Additionally or alternatively to one of more of the examples disclosed above, in some examples, the method further comprises while in the second mode, in accordance with a determination that one or more third criteria are satisfied, presenting the notification from the application on the electronic device after a threshold amount of time. Additionally or alternatively to one of more of the examples disclosed above, in some examples, the method further comprises while in the second mode, in accordance with a determination that one or more fourth criteria are satisfied, presenting the notification from the application on a second electronic device communicatively coupled to the electronic device and forgoing presenting the notification on the electronic device. Additionally or alternatively to one of more of the examples disclosed above, in some examples, the method further comprises while in the second mode, in accordance with the determination that the one or more second criteria are not satisfied, presenting the notification from the application on the electronic device. Additionally or alternatively to one of more of the examples disclosed above, in some examples, forgoing presenting the notification from the application further comprises forgoing presenting the notification while the electronic device is in the second mode. Additionally or alternatively to one of more of the examples disclosed above, in some examples, forgoing presenting the notification from the application further comprises presenting the notification after a threshold amount of time. Additionally or alternatively to one of more of the examples disclosed above, in some examples, forgoing presenting the notification comprises causing the notification to be presented on a second electronic device communicatively coupled to the electronic device and forgoing presenting the notification on the electronic device. Additionally or alternatively to one of more of the examples disclosed above, in some examples, the one or more second criteria include a criterion that is satisfied when the notification corresponds to a communication from a non-designated contact. Additionally or alternatively to one of more of the examples disclosed above, in some examples, the method further comprises while in the first mode, detecting, using the one or more input devices including the optical sensor, a second event; and in accordance with a determination that the second event satisfies one or more fifth criteria, the one or more fifth criteria including a criterion that is satisfied when detecting an obstacle while in a navigational context, transitioning the electronic device from the first mode to a third mode. Additionally or alternatively to one of more of the examples disclosed above, in some examples, presenting the one or more notifications that were received and not presented while in the second mode further includes presenting one or more summaries corresponding to the one or more notifications. Additionally or alternatively to one of more of the examples disclosed above, in some examples, the one or more second criteria include an importance criterion that is satisfied when the notification has an importance less than the importance criterion.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is viewing content of communication items and summarizing that content.

The present disclosure recognizes that the use of such personal information data, in the present technology, can be used to the benefit of users. For example, personal information data may be used to change the mode of the electronic device. For example, the electronic device changes the mode based on changes to the user's environment and/or interactions with the environment.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at an electronic device in communication with one or more displays and one or more input devices:
while in a first mode, detecting, using the one or more input devices including an optical sensor, an event;
in accordance with a determination that the event satisfies one or more first criteria, the one or more first criteria including a first criterion that is satisfied when the event corresponds to an interaction with a person, transitioning the electronic device from the first mode to a second mode;
while in the second mode:
receiving a notification from an application; and
in accordance with a determination that one or more second criteria are satisfied, forgoing presenting the notification from the application on the electronic device.

2. The method of claim 1, further comprising:
in accordance with a determination that the event does not satisfy the one or more first criteria, foregoing transitioning the electronic device from the first mode to the second mode.

3. The method of claim 1, further comprising:
while in the second mode, in accordance with a determination that the event has ended, transitioning the electronic device from the second mode to the first mode.

4. The method of claim 3, further comprising:
in response to transitioning the electronic device from the second mode to the first mode, presenting one or more notifications that were received and not presented while in the second mode.

5. The method of claim 4, wherein presenting the one or more notifications that were received and not presented while in the second mode further includes presenting one or more summaries corresponding to the one or more notifications.

6. The method of claim 1, wherein the one or more input devices further include an audio sensor, and detecting the event using the one or more input devices including the optical sensor and the audio sensor comprises determining an identity of the person and detecting audio information using the one or more input devices.

7. The method of claim 1, further comprising:
while in the second mode, in accordance with a determination that one or more third criteria are satisfied, presenting the notification from the application on the electronic device after a threshold amount of time.

8. The method of claim 1, further comprising:
while in the second mode, in accordance with a determination that one or more fourth criteria are satisfied, presenting the notification from the application on a second electronic device communicatively coupled to the electronic device and forgoing presenting the notification on the electronic device.

9. An electronic device comprising:
one or more displays;
one or more input devices;
a memory;
one or more processors; and
one or more programs stored in the memory and configured to be executed by the one or more processors, the one or more programs including instructions for:
while in a first mode, detecting, using the one or more input devices including an optical sensor, an event;
in accordance with a determination that the event satisfies one or more first criteria, the one or more first criteria including a first criterion that is satisfied when detecting an interaction with a person, transitioning the electronic device from the first mode to a second mode;
while in the second mode:
receiving, a notification from an application; and
in accordance with a determination that one or more second criteria are satisfied, forgoing presenting the notification from the application on the electronic device.

10. The electronic device of claim 9, further comprising:
in accordance with a determination that the event does not satisfy the one or more first criteria, foregoing transitioning the electronic device from the first mode to the second mode.

11. The electronic device of claim 9, further comprising:
while in the second mode, in accordance with a determination that the event has ended, transitioning the electronic device from the second mode to the first mode.

12. The electronic device of claim 11, further comprising:
in response to transitioning the electronic device from the second mode to the first mode, presenting one or more notifications that were received and not presented while in the second mode.

13. The electronic device of claim 12, wherein presenting the one or more notifications that were received and not presented while in the second mode further includes presenting one or more summaries corresponding to the one or more notifications.

14. The electronic device of claim 9, wherein the one or more input devices further include an audio sensor, and detecting the event using the one or more input devices including the optical sensor and the audio sensor comprises determining an identity of the person and detecting audio information using the one or more input devices.

15. The electronic device of claim 9, further comprising:
while in the second mode, in accordance with a determination that one or more third criteria are satisfied, presenting the notification from the application on the electronic device after a threshold amount of time.

16. The electronic device of claim 9, further comprising:
while in the second mode, in accordance with a determination that one or more fourth criteria are satisfied, presenting the notification from the application on a second electronic device communicatively coupled to the electronic device and forgoing presenting the notification on the electronic device.

17. A non-transitory computer readable storage medium storing one or more programs, the one or more programs comprising instructions, which when executed by one or more processors of an electronic device, cause the electronic device to perform a method comprising:
while in a first mode, detecting, using one or more input devices including an optical sensor, an event;
in accordance with a determination that the event satisfies one or more first criteria, the one or more first criteria including a first criterion that is satisfied when the event corresponds to an interaction with a person, transitioning the electronic device from the first mode to a second mode;
while in the second mode:
receiving a notification from an application; and
in accordance with a determination that one or more second criteria are satisfied, forgoing presenting the notification from the application on the electronic device.

18. The non-transitory computer readable storage medium of claim 17, further comprising:
in accordance with a determination that the event does not satisfy the one or more first criteria, foregoing transitioning the electronic device from the first mode to the second mode.

19. The non-transitory computer readable storage medium of claim 17, further comprising:
while in the second mode, in accordance with a determination that the event has ended, transitioning the electronic device from the second mode to the first mode.

20. The non-transitory computer readable storage medium of claim 19, further comprising:
in response to transitioning the electronic device from the second mode to the first mode, presenting one or more notifications that were received and not presented while in the second mode.

21. The non-transitory computer readable storage medium of claim 20, wherein presenting the one or more notifications that were received and not presented while in the second mode further includes presenting one or more summaries corresponding to the one or more notifications.

22. The non-transitory computer readable storage medium of claim 17, wherein the one or more input devices further include an audio sensor, and detecting the event using the one or more input devices including the optical sensor and the audio sensor comprises determining an identity of the person and detecting audio information using the one or more input devices.

23. The non-transitory computer readable storage medium of claim 17, further comprising:
while in the second mode, in accordance with a determination that one or more third criteria are satisfied, presenting the notification from the application on the electronic device after a threshold amount of time.

24. The non-transitory computer readable storage medium of claim 17, further comprising:
while in the second mode, in accordance with a determination that one or more fourth criteria are satisfied, presenting the notification from the application on a second electronic device communicatively coupled to the electronic device and forgoing presenting the notification on the electronic device.
